(19) United States
(12) Patent Application Publication
(10) Pub. No.: US 2004/0045106 A1
(43) Pub. Date: Mar. 11, 2004

(54) Electric toothbrush

(76) Inventor: Chun-Shun Lam, Kwai Chung (HK)

Correspondence Address: James A. LaBarre, BURNS, DOANE, SWECKER & MATHIS, L.L.P., P.O. Box 1404, Alexandria, VA, 22313-1404, US

(21) Appl. No.: 10/234,532

(22) Filed: Sep. 5, 2002

(51) Int. Cl. A61C 17/22

(52) U.S. Cl. 15/22.1

(57) ABSTRACT

Typical electric toothbrush brushes pivotally, which is quite different from the non-electronic counterpart. The electric toothbrush (10) of this invention includes an axial brush section (40) movable in an axial direction substantially perpendicular to the toothbrush handle (14), which defines a longitudinal direction. The electric toothbrush (10) of this invention may brush teeth in a way resembling that of using traditional non-electric toothbrush, as the axial brush section is moving along the direction of tooth growth.

### FIELD OF THE INVENTION

This invention relates to electric toothbrush.

### BACKGROUND OF THE INVENTION

A traditional electric toothbrush includes a motor housed in a housing. The motor is connected to a shaft for pivoting a pivotal brush section at one end of the toothbrush repeatedly. However, this brushing motion is quite different from the non-electronic counterpart Some users may not prefer this kind of pivotal brushing, particularly those suffering from tooth gum problems.

### OBJECTS OF THE INVENTION

Therefore, it is an object of this invention to resolve at least one or more of the problems as set forth in the prior art. As a minimum, it is an object of this invention to provide the public with a useful choice.

### SUMMARY OF THE INVENTION

Accordingly, this invention provides an electric toothbrush including a housing defining a handle along a longitudinal direction; a motor housed by the housing; and a shaft connected to and rotated by the motor. The electric toothbrush is characterized in the provision of a lateral brush section actuable in a lateral direction substantially perpendicular to the longitudinal direction, and a lateral actuating member connected to the shaft for actuating the lateral brush section. The lateral actuating member is relatively fixed to the lateral brush section in the lateral direction while accommodates relative movement between the lateral brush section and the actuating member in the longitudinal direction.

Preferably, the lateral actuating member and the shaft are unitary. More preferably, the lateral actuating member is a lateral bent portion of the shaft. The lateral bent portion is further preferred to be substantially C-shaped,

In another preferred embodiment, the lateral brush section includes a lateral recess for receiving the lateral actuating member. More preferably, the lateral recess is substantially rectangular along the longitudinal direction. Alternatively, the lateral recess can have two lateral acting members substantially in the middle of the rectangular lateral recess for acting against the lateral actuating member.

Optionally, the electric toothbrush this invention may further include a pivotal brush section actuated by a pivotal actuating member connected to the shaft.

Preferably, the pivotal actuating member and the shaft are unitary. The pivotal actuating member is also preferred to be an substantially obtuse L-shaped bent portion of the shaft. More preferably, the obtuse L-shaped pivotal bent section opposes the substantially C-shaped lateral bent section. Alternatively, obtuse L-shaped pivotal bent section does not oppose the substantially C-shaped lateral bent section.

### BRIEF DESCRIPTION OF THE DRAWINGS

Preferred embodiments of the present invention will now be explained by way of example and with reference to the accompany drawings in which;

FIG. 1 shows the electric toothbrush of this invention;

FIG. 2 shows a perspective view of the inner structure of the electric toothbrush in FIG. 1;

FIG. 3 shows an expanded view of the electric toothbrush including a brush section;

FIG. 4 shows the recess of the brush section engaging with the actuating member;

FIG. 5 shows a cross section view along A-A′ in FIG. 1;

FIG. 6a to 6d shows the actuation of the brush section by the actuating member;

FIG. 7 shows a typical electric toothbrush having a pivotal brush section incorporating the lateral brush section of this invention;

FIG. 8 shows a perspective view of the inner structure of the electric toothbrush in FIG. 7;

FIG. 9 shows an expanded view of the electric toothbrush of FIG. 7 including a lateral brush section and a pivotal brush section; and

FIG. 10a to 10d shows the actuation of the lateral and pivotal brush sections by the actuating members on the shaft.

### DETAILED DESCRIPTION OF THE PREFERRED EMBODIMENT

This invention is now described by ways of example with reference to the figures in the following paragraphs. List 1 is a part list so that the reference numerals in the figures may be easily referred to.

Objects, features, and aspects of the present invention are disclosed in or are obvious from the following description. It is to be understood by one of ordinary skill in the art that the present discussion is a description of exemplary embodiments only, and is not intended as limiting the broader aspects of the present invention, which broader aspects are embodied in the exemplary constructions.

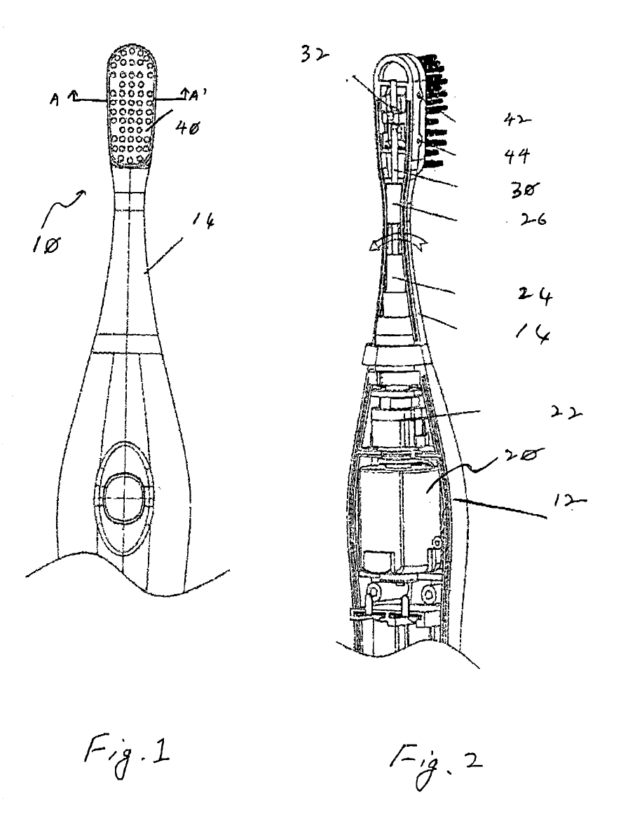

Unlike traditional electric toothbrushes, the electric toothbrush (10) of this invention shown in FIG. 1 includes a lateral brush section (40) movable in a lateral direction substantially perpendicular to the toothbrush handle (14), which defines a longitudinal direction, preferably reciprocally. Thus the electric toothbrush (10) of this invention may brush teeth in a way resembling that of using traditional non-electric toothbrush, as the lateral brush section is moving parallel to the direction of tooth growth.

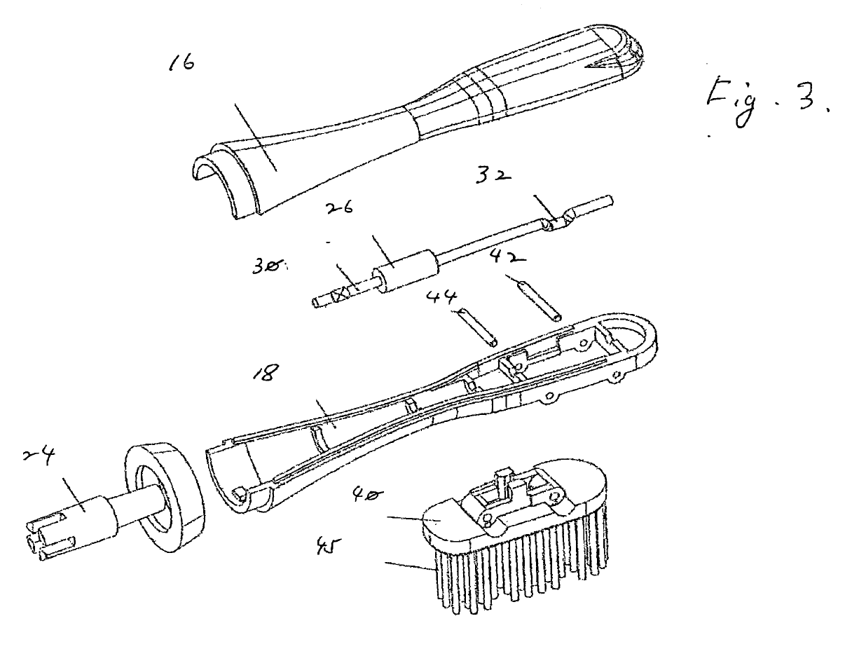

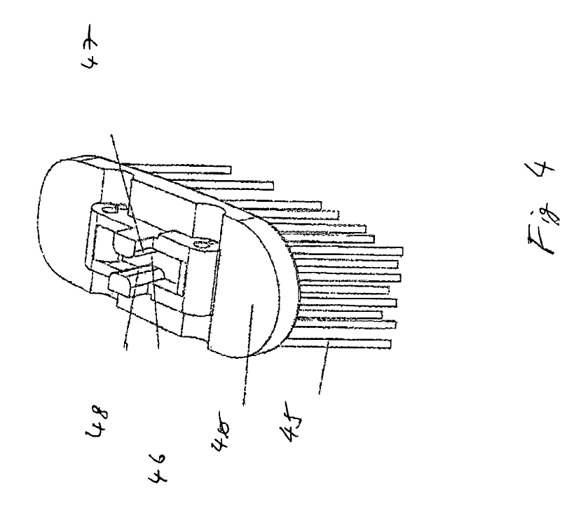

Referring to FIG. 2, the toothbrush housing (12) houses the motor (20). A shaft (30) is connected to and rotated by the motor (20) as shown. The shaft (30) has an actuating member (32), as shown in FIG. 3. The actuating member (32) and the shaft (30) are preferred to be unitary to reduce complexity and costs, even though the actuating member (32) can be a separate piece attached to the shaft (30). The actuating member is preferred to be a bent portion (32) (32), more preferably substantially C or U-shaped in the form of a crank shaft. However, other shapes may be used. For example, the actuating member (32) can be ball-shaped, but this may be less preferred due to higher material costs.

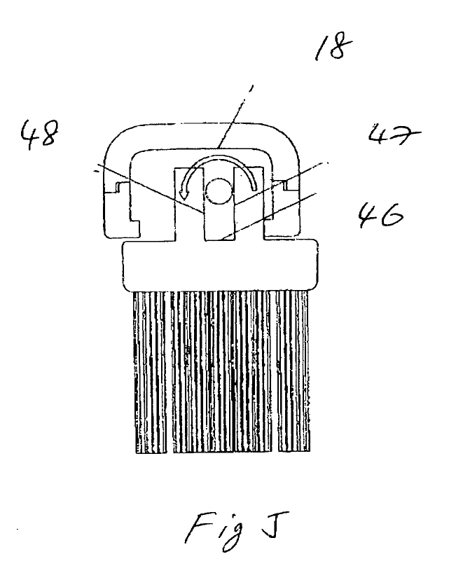

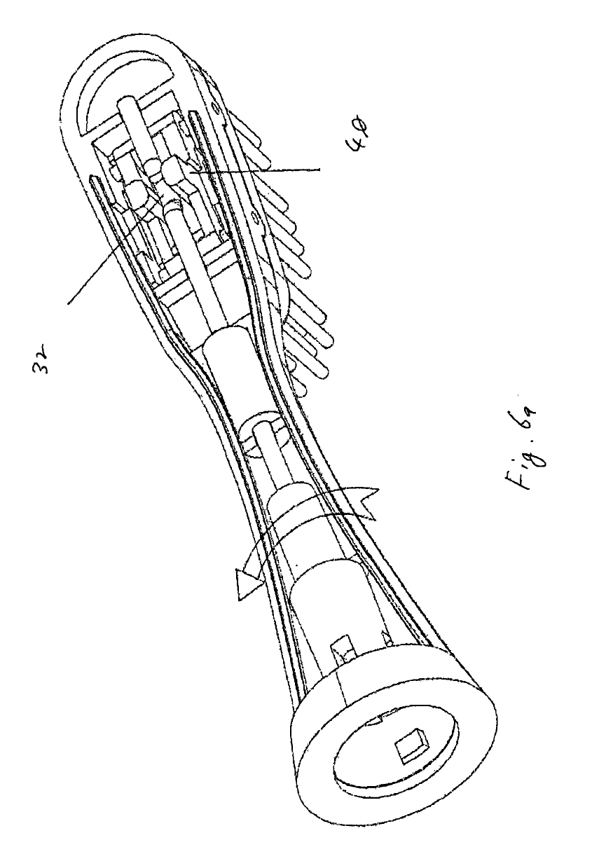

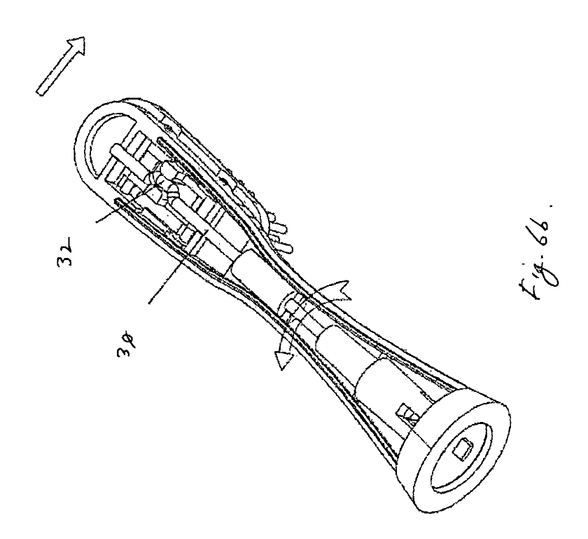

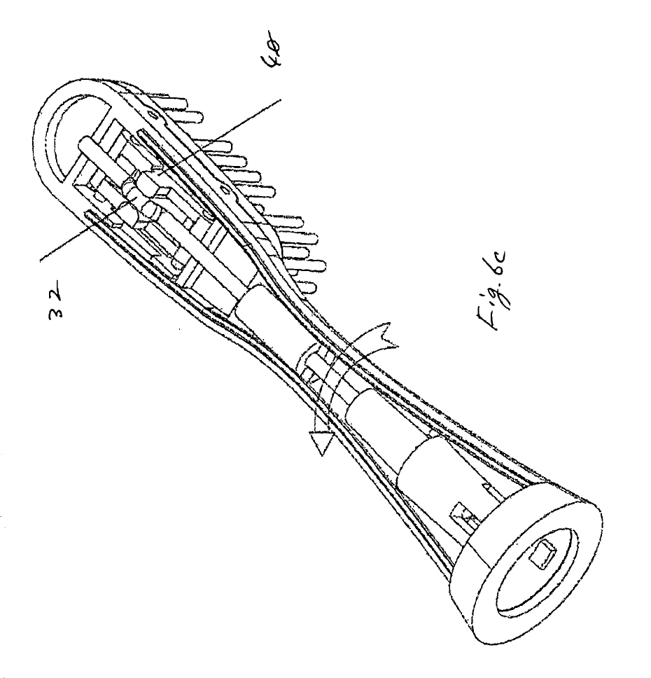

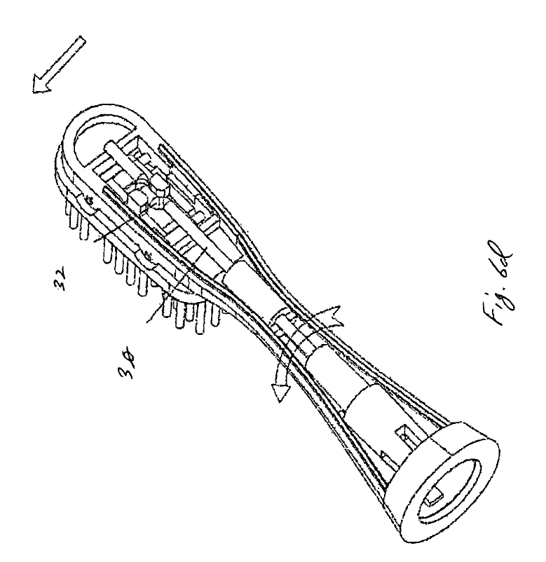

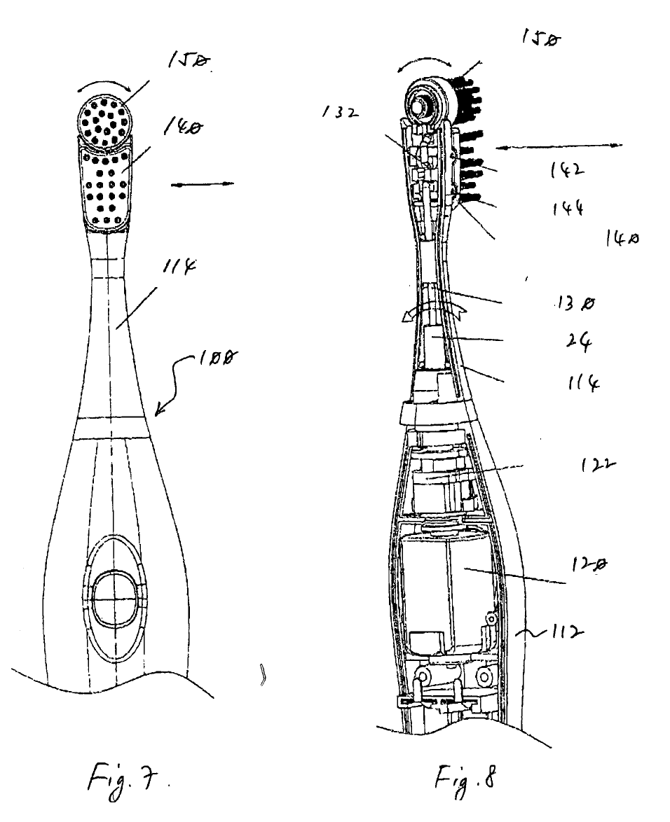

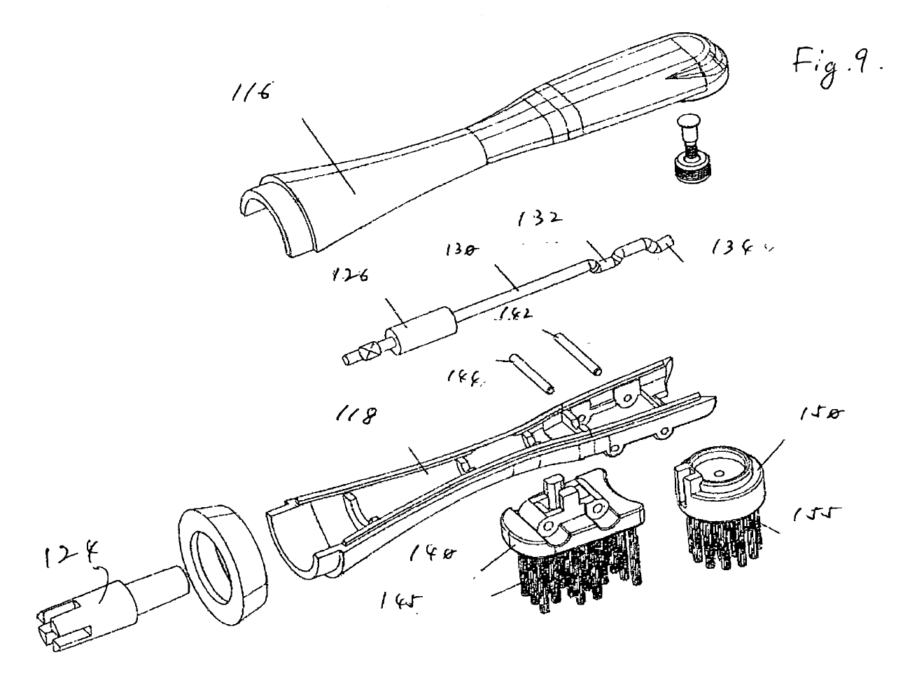

Brush (45) is mounted on the lateral brush section (40). To receive and interact with the actuating member (32), the electric lateral brush section (40) is preferred to have a recess (46) on the side opposing the brush (45), as shown in FIG. 4. Two sliding shafts (42,44) may connect with the lateral brush section (40) to affix the cartridge onto the housing (12) to enhance stability of the lateral brush section (40), as shown in FIGS. 2 and 3, but, of course, other suitable mechanical arrangements may be used, like ball-and-socket arrangements.

The recess (46) may be preferred to be rectangular, and may include two acting members (47,48) for acting against the actuating member (32). The two acting members (47,48) are preferred to be positioned substantially in the middle of the rectangular recess (46) for acting against the actuating member (32) for simplicity. However, for example, one acting member (47) may be positioned at one end of the rectangular recess (46) while the other acting member (48) may be positioned at another end, but this arrangement may required the presence of two bent portions in the actuating member (32), and is therefore less preferred due to higher manufacturing complexity.

Any connection that relatively fixes the brush to the actuating member (32) in the lateral direction while accommodates relative movement between the lateral brush section (40) and the actuating member (32) in the perpendicular direction may suffice.

An example of the actuation of the lateral brush section (40) is now described. First, the motor rotates the shaft (30). When the bent portion (32) of the shaft (30) faces downward (FIG. 6a), the lateral brush section (40) is in the middle position. When the shaft (30) rotates and the bent portion (32) is turned to the night, the bent portion (32) engages with the right acting member (48) of the recess of the brush sliding shaft (FIG. 6b), moving the brush sliding shaft to the right. When the bent portion (32) of the shaft (30) faces upward (FIG. 6c), the bent portion (32), the lateral brush section (40) moves back to the central position. When the bent portion (32) of the longitudinal shaft (30) rotates to the left (FIG. 6d), the bent portion (32) engages with the left acting member (47) of the recess of the lateral brush section (40), moving the lateral brush section (40) to the left. The bent portion (32) then returns to the lower position when the longitudinal shaft (30) continues to rotate, and returning the lateral brush section (40) to the central position. These four steps form a continuous cycle. Therefore, as the longitudinal shaft (30) rotates continuously, the bent portion (32) attached to the shaft (30) moves the lateral brush section (40) reciprocally and continuously, causing the lateral brush section (40) to “vibrate” in a direction perpendicular to the handle (14) of the electric toothbrush (10).

The horizontal vibrating structure of the brash head of this invention may be used with other brush head constructions to satisfy different customer's needs.

FIGS. 7 and 8 show a typical electric toothbrush (100) having a pivotal brush section (150) incorporating the horizontal lateral brush section (140) of this invention. The pivoting and horizontally vibrating motions of these brush sections (140,150) are actuated by the shaft (130), which is in turn driven by the motor (120), such that the two different brush sections work simultaneously. Again, the lateral brush section (140) moves in a lateral direction substantially perpendicular to the toothbrush handle (114), which defines a longitudinal direction. Of course, the lateral and pivotal brush sections (140,150) include lateral and pivotal brushes (145,155)

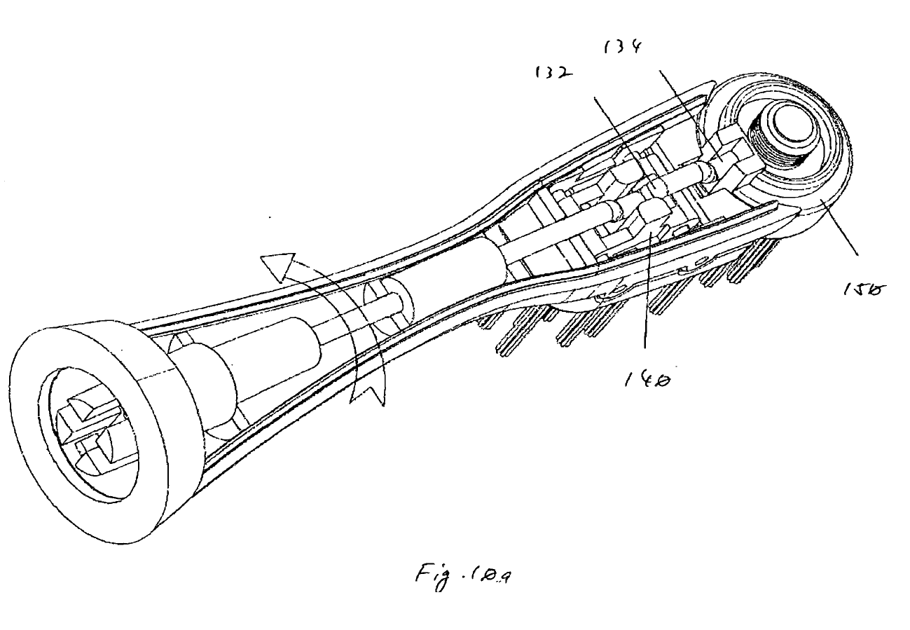

Referring to FIG. 9, the toothbrush housing (112) houses the motor (20). A shaft (130) is connected to and rotated by the motor (120) as shown. The shad (130) has a lateral actuating member (132) and a pivotal actuating member (134). Again, the actuating members (132,134) and the shaft (30) are preferred to be unitary to reduce complexity and costs, even though the actuating members (132,134) can be a separate piece attached to the shaft (130). The lateral actuating member is preferred to be a lateral bent portion (132), more preferably substantially C or U-shaped, but other shapes may be used as described above. The pivotal actuating member is preferred to be a pivotal bent portion (134), more preferably substantially an obtuse L-shaped, as shown in FIG. 9. Although other shapes may be used for the pivotal bent portion (134), this may be the subject other documents and will not be described here further.

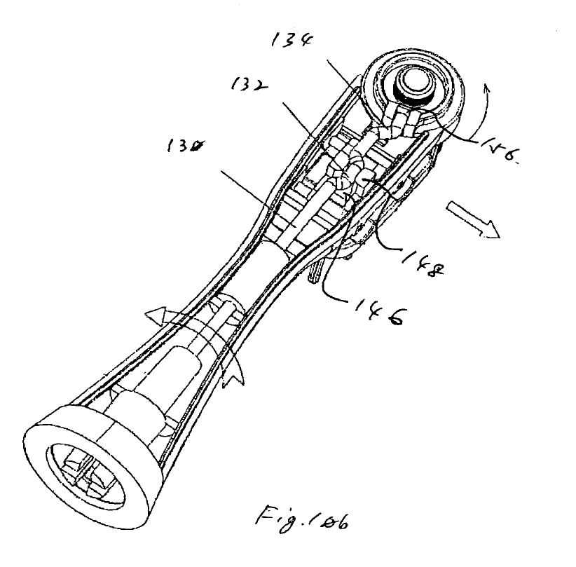

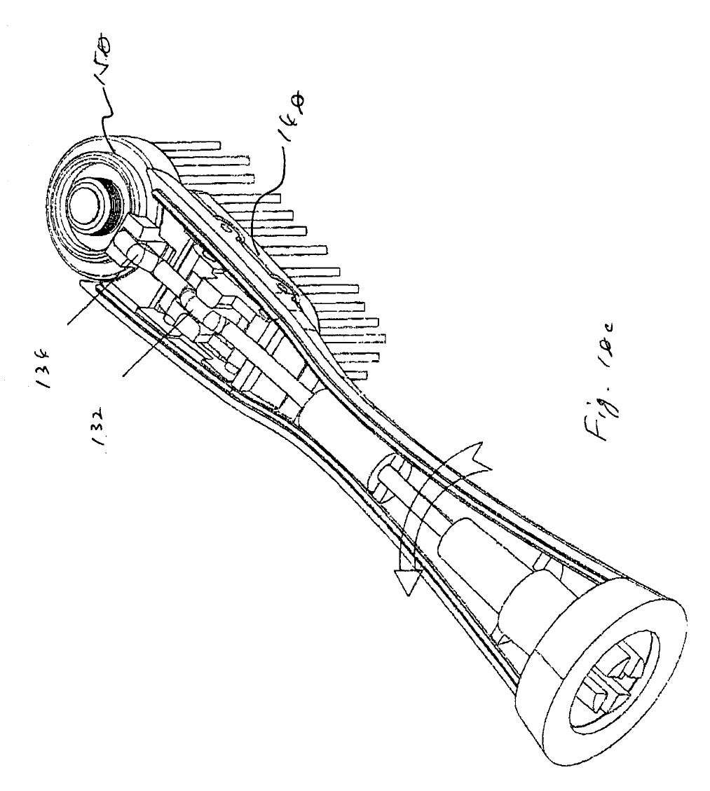

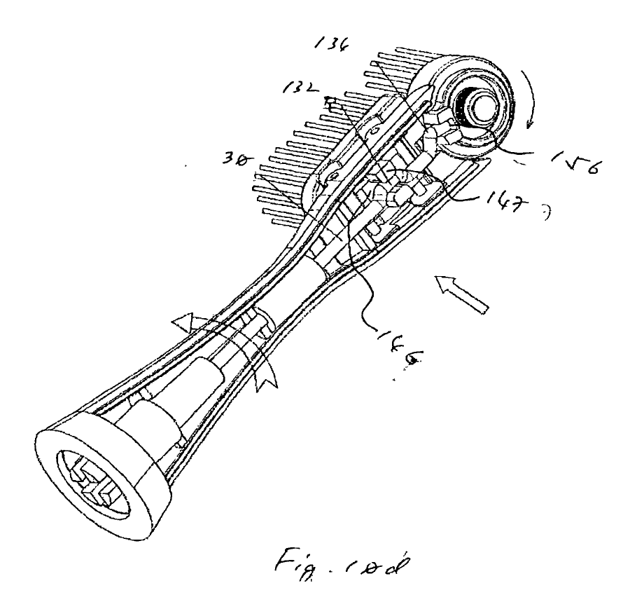

An example of the working of the electric toothbrush (100) is now described. Lateral bent portion (132) drives the horizontally vibrating brush portion as described above. The working of the pivotal bent portion (134) is illustrated in FIGS. 10a to 10d. The motor drives the shaft (130). When the bent portions (132,134) face downward (FIG. 12a), both of the lateral brush section (140) and pivotal brush (150) sections are in the central position. When the shaft rotates and the bent portion (132,134) arc moved to the right (FIG. 10b), the lateral bent portion (132) engages the right acting member (148) of the lateral recess (146) of the lateral brush section (140), moving the lateral brush section (40) to the right; similarly, pivotal bent portion (134) also engage the right inner wall of the pivotal recess (156) of the pivotal brush section (150), rotating the pivotal brush section (150) in an anti-clockwise direction.

Of course, the obtuse L-shaped pivotal bent section (134) can be arranged to be opposing the C or U-shaped lateral bent section (132) such that the pivotal brush section (150) rotates in a clockwise direction when the lateral brush section (140) moves to the right, or vice versa.

When the bent portions (132,134) face upward (FIG. 10c), the lateral brush section (140) and the pivotal brush section (150) move back to the central position. When the lateral bent portion (132) rotates to the left, the lateral bent portion (132) engages with the left acting member (147) of the lateral recess (146), moving the lateral brush section (140) to the left. The pivotal bent portion (134) will engage with the left inner wall of pivotal recess (156) of the pivotal brush section, rotating the pivotal brush section (150) in a clockwise direction as shown in FIG. 10d. The bent portions (132,134) then return to the central position when the longitudinal shaft (130) continues to rotate, and returning the lateral and pivotal brush sections (140,150) to the central position. These four steps form a continuous cycle. Therefore, as long as the shaft (130) rotates continuously, the lateral bent portion (132) causes the lateral brush section (140) to “vibrate” in a direction perpendicular to the handle (114) of the electric toothbrush (100), while the pivotal bent portion (134) rotates the pivotal brush section reciprocally.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. An electric toothbrush (10) including:
a housing (12) defining a handle (14) along a longitudinal direction;
a motor (20) housed by the housing (12); and
a shaft (30) connected to and rotated by the motor (20);
characterized in that the electric toothbrush (10) further including;
a lateral brush section (40) actuable in a lateral direction substantially perpendicular to the longitudinal direction; and
a lateral actuating member (32) connected to the shaft (30) for actuating the lateral brush section (40).
wherein the lateral actuating member (32) is relatively fixed to the lateral brush section (32) in the lateral direction while accommodates relative movement between the lateral brush section (40) and the actuating member (32) in the longitudinal direction.

2. The electric toothbrush (10) of claim 1, wherein the lateral actuating member (32) and the shaft (30) are unitary.

3. The electric toothbrush (10) of claim 2, wherein the lateral actuating member is a lateral bent portion (32) of the shaft (30).

4. The electric toothbrush (10) of claim 3, wherein the lateral bent portion (32) is substantially C-shaped.

5. The electric toothbrush (10) of claim 1, wherein the lateral brush section (40) includes a lateral recess (46) for receiving the lateral actuating member (32).

6. The electric toothbrush (10) of claim 5, wherein the lateral recess (46) is substantially rectangular along the longitudinal direction.

7. The electric toothbrush (10) of claim 5, wherein the lateral recess (46) has two lateral acting members substantially in the middle of the rectangular lateral recess (46) for acting against the lateral actuating member (32).

8. The electric toothbrush (100) of claim 4 further including a pivotal brush section (150) actuated by a pivotal actuating member (134) connected to the shaft (130).

9. The electric toothbrush (100) of claim 8, wherein the pivotal actuating member (134) and the shaft (130) are unitary.

10. The electric toothbrush (100) of claim 9, wherein the pivotal actuating member is an substantially obtuse L-shaped bent portion of the shaft (130).

11. The electric toothbrush (100) of claim 10, wherein obtuse L-shaped pivotal bent section (134) opposes the substantially C-shaped lateral bent section (132).

12. The electric toothbrush (100) of claim 10, wherein obtuse L-shaped pivotal bent section (134) does not oppose the substantially C-shaped lateral bent section (132).
